(19) United States
(12) Patent Application Publication
(10) Pub. No.: US 2005/0236319 A1
(43) Pub. Date: Oct. 27, 2005

(54) Pendant drop control in a multiwell plate

(75) Inventors: Marc Richard Emerick, Rye, NH (US); Christopher A. Scott, Westford, MA (US); Steven D. Sheridan, Wakefield, MA (US)

Correspondence Address: MILLIPORE CORPORATION, 290 CONCORD ROAD, BILLERICA, MA, 01821, US

(73) Assignee: Millipore Corporation, Billerica, MA (US)

(21) Appl. No.: 11/062,116

(22) Filed: Feb. 18, 2005

Related U.S. Application Data
(60) Provisional application No. 60/564,999, filed on Apr. 23, 2004.

(51) Int. Cl. B01D 25/02

(52) U.S. Cl. 210/323.1; 210/498; 422/104; 422/101

(57) ABSTRACT

The present invention is to a filter plate and a collection system having an upper filter plate and a lower collection plate. Each has two or more wells in register with each other. The filter plate has an underdrain containing a spout. The spout is offcenter of the centerpoint of the wells between which it resides. The spout is close to at least one wall of the well of the collection device but set off from that wall by a distance sufficient to ensure easy assembly and disassembly of the devices without contact or damage of the spout with the well of the collection device. In this manner, any drop that begins to form contacts the adjacent well wall and travels down it into the collection device.

### CROSS REFERENCE RELATED APPLICATIONS

This application claims the benefit of U.S. Provisional Application Ser. No. 60/564,999, filed on Apr. 23, 2004.

### BACKGROUND OF THE INVENTION

The use of multiwell plates to filter and purify various products such as proteins, DNA, RNA, plasmids and the like or for use in drug screening or drug discovery in the laboratory is widespread and growing. The advantages are many. The ability to use small volumes of samples required especially with experimental compounds or with the screening of 1000s of potential compounds reduces cost. The ability to run multiple samples at the same time reduce time and cost.

Most plate-based systems are arranged to have a filter plate positioned above a collection device such as a collection plate. A typical system is shown in FIG. 1. The filter plate 2 has a series of wells 4, typically 96 or 384 or 1536 arranged in orderly rows and columns. The bottom 6 of each well 4 has an opening 8 that is selectively closed by one or more filters or membranes 10. The collection plate 12 typically has the same number of wells 14 as the filter plate and they are aligned with those of the filter plate so that they collect the fluid from the respective well above it. The bottom 16 of the wells 14 of the collection plate 12 is generally closed as shown.

All fluid in the filter plate must pass through the filter or membrane 10 before reaching the collection plate well 14. Most filter plates 2 also contain an underdrain 18 below the filter or membrane 10. The underdrain 18 generally contains a spout 20 (as shown) to direct the fluid from the filter plate 2 to the well 14 of the collection plate 12 below it. The spout 20 also acts to hold back fluid flow through it when it is subject to simple atmospheric pressure. Flow occurs with aqueous based fluids only when a sufficient pressure differential, such as a vacuum is applied to the system. It also contains some type of sloped surface 22 to cause the fluid in the underdrain 18 to move toward the spout 20.

In practice, the system is assembled and placed on a vacuum manifold. The vacuum draws the fluid through the filter plate and underdrain and into the collection device. However, some fluid remains behind after the filtration has been completed. Typically, this fluid is found in the underdrain and as a pendant drop extending downward from the opening.

Several problems exist with leaving some sample behind.

For smaller volume application such as 384 and 1536 well systems (these systems include that number of wells on a plate that is of the same size as that used for a 96 well plate, meaning that the well size and sample size respectively 4× and 16× smaller than that of a 96 well plate system) the loss of sample can amount to 10 to 20% of the entire sample.

For all multiwell systems, the fluid in the pendant drops can often migrate to adjacent wells along adjacent surfaces or the pendant drops can be transferred to an adjacent well when the plates are taken apart to obtain the material in the collection plate. This leads to cross contamination of the sample and reduces the reliability of the system and the test that has been run. Likewise, many systems run sequential steps in the same system. The residual material can either then be present in the second step collection sample which is undesirable or it can over time migrate back or wick back through the filter or membrane and be present in the well of the filter plate from which it was removed. If for example the first step was a desalting step to remove salts or primers or other chemicals from a sample, this leads to a less pure sample and may complicate the second or later steps performed upon it. Additionally, when the filter plate is removed from the manifold, any pendant drops tend to rain down on the collection plate, equipment and adjacent laboratory surfaces thereby contaminating them.

Several approaches have been made to resolve the issue of pendant drop formation.

U.S. Pat. No. 4,902,481 uses a specially designed spout configuration having a collar which extends in a direction perpendicular to the vertical axis of the spout so that the collar and spout outer surface prevent pendant drop migration and direct any pendant drops into the collection well.

It however merely controls the pendant drop's lateral movement, not its formation or its migration into the collection plate.

In U.S. Pat. No. 4,526,690 the use of a hydrophobic porous layer at the bottom of each well prevented pendant drops from forming. However, when sufficient pressure is applied to the system the liquid overcomes the hydrophobic resistance and flows through the membrane to the collection plate. Additionally, the use of a separate grid of drop guiding projections, arranged between the two plates, is used to pull any drops that are formed along its surfaces and into the collection well.

In many applications the use of a hydrophobic membrane is not suitable. Even when they may be suitable, the vacuum required is higher than normally used as it needs to overcome the phobic resistance of the filter.

Likewise, the use of the separate grid with the hydrophobic system has not proven to be successful. Plates by different manufacturers can vary in their dimensions making such grids often plate specific. Additionally and more importantly, many plates are handled robotically and the introduction of a component that is loose and not easily gripped by robotic arms is not acceptable. Additionally, robotics are not exact and their handling often leads to overcompression of the plates which in turn leads to puncturing of the membrane by the grids which is unacceptable. To date no commercial embodiment of this design has been introduced.

US 2002/0179520A1 and 2002/0150505A1 uses the normal plate system and moves the top plate relative to the collection plate before they are completely pulled apart so as to cause any pendant drop to touch off on one or more walls of the collection wells. Preferably, this is accomplished by a movement of both plates relative to each other in a first and then in an opposite direction so there are two touch off attempts.

This idea requires specialized robotic equipment to create the relative movement between the plates. Additionally, the plate dimensions and movements need to be tightly controlled in order to ensure that the spout moves sufficiently close to the first and optimally the second wall of the well to create the touch off function while not moving the spout too close to cause an actual touching which could potentially damage the plate system.

U.S. Pat. No. 5,108,704 teaches the formation of a unique filter plate design in which the spout is located at an edge of the well beyond the point below the active filter area. The spout is designed to mate with the wall of the collection plate so that no drop is formed and all liquid flows down the wall. For plates with more than 96 wells (e.g. 384) there is not enough room on the standard plate size (as defined by the American National Standards Institute/Society for Biological Standards (ANSI/SBS) which sets industry standards for among other things, device sizes including multiwell plate dimensions standards), for the spout to be outside the active membrane area and still conform to the ANSI/SBS dimension standards. This limits that plate's applicability and acceptability.

This product has not been successfully commercialized. It requires the use of a new plate design. Moreover it requires that both the filter plate and the collection plate be made to high tolerances in order to create the exact fit required. Such a device is not acceptable in robotic applications in that the robots don't have the fine control necessary to mate and detach the plates. As such they would be continuously jammed and/or damaged making them useless.

What is desired is a device that provides the advantages of the current multiwell plate system but which reduces or eliminates the issue of pendant drops or at the very least controls them and which is robotically friendly. Moreover, it is desired to have a device that provides consistent pendant drop removal across the length and breadth of the plate. The present invention provides such a system.

### SUMMARY OF THE INVENTION

The present invention relates to a multiwell plate having pendant drop control. More particularly, it relates to a multiwell plate having an opening in its bottom located so as to provide pendant drop control into the collection device downstream of the opening.

The present invention is to a filter plate and a collection system having an upper filter plate and a lower collection device. The filter plate has has two or more wells in register with the collection device. The filter plate has an underdrain having a lower opening that is in fluid communication with the collection device. It preferably contains a spout. The opening is offcenter of the centerpoint of the wells between which it resides. The opening is close to at least one wall of the well of the collection device but set off from that wall by a distance sufficient to ensure easy assembly and disassembly of the devices without contact or damage of the opening, especially when in the form of a spout within the well of the collection device. In this manner, any drop that begins to form contacts the adjacent surface of the collection device and travels down it into the collection device.

It is an object of the present invention to provide a multiple well filter plate comprising a plate having a top, a bottom and a thickness between the top and the bottom, a plurality of wells extending through the thickness, each well having an open top and at least a partially open bottom, a filter located adjacent the bottom to form a permeably selective opening to the bottom, an underdrain having a top surface, a bottom surface and a thickness in between, the top surface of the underdrain attached to the bottom of the plate, the underdrain having a series of chambers that register and mate with the bottom of the plurality of wells of the plate so as to ensure that fluid passing through the filter of a selected well enters only the respective chamber of the underdrain, each chamber having an opening through the bottom surface of the underdrain to an outside environment and each opening being offset from a centerpoint determined by the intersection of two or more diameters of the registered well of the collection device and chamber of the underdrain.

It is an object of the present invention to provide a multiple well plate filtration system comprising a filter plate having a top, a bottom and a thickness between the top and the bottom, a plurality of wells extending through the thickness, each well having an open top and at least a partially open bottom, a filter located adjacent the bottom to form a permeably selective opening to the bottom, an underdrain having a top surface, a bottom surface and a thickness in between, the top surface of the underdrain attached to the bottom of the plate, the underdrain having a series of chambers formed in its thickness that register and mate with the bottom of the plurality of wells of the plate so as to ensure that fluid passing the filter of a selected well enters only the respective chamber of the underdrain, each chamber having an opening through the bottom surface of the underdrain to an outside environment, a collection device located below the underdrain, the collection device having a top, a bottom and a thickness between the top and the bottom, a plurality of wells extending through the thickness, each well having an open top, each well of the collection plate is in align with a well of the filter plate and its associated underdrain chamber and opening and the opening of the underdrain has the ability to form a pendant drop of a radius R, the opening being located adjacent at least one wall of the collection device by a distance of between about 0.05 R and less than about 1 R.

It is another object to provide a multiple well plate filtration system comprising a filter plate having a top, a bottom and a thickness between the top and the bottom, a plurality of wells extending through the thickness, each well having an open top and at least a partially open bottom, a filter located adjacent the bottom to form a permeably selective opening to the bottom, an underdrain having a top surface, a bottom surface and a thickness in between, the top surface of the underdrain attached to the bottom of the plate, the underdrain having a series of chambers formed in its thickness that register and mate with the bottom of the plurality of wells of the plate so as to ensure that fluid passing the filter of a selected well enters only the respective chamber of the underdrain, each chamber having an opening through the bottom surface of the underdrain to an outside environment, a collection device located below the underdrain, the collection device having a top, a bottom and a thickness between the top and the bottom, a plurality of wells extending through the thickness, each well having an open top, each well of the collection plate is in align with a well of the filter plate and its associated underdrain chamber and opening and the opening is capable of forming a pendant drop of a radius of R, and wherein the opening is offset from an inner wall of the well of the collection device by a distance of from about 0.05 R to less than about 1 R.

It is an additional object to provide a device for separating a liquid sample comprising:
an upper plate having at least two wells integrally connected together, each well having an upper opening and a lower opening, the lower opening being positioned on a bottom surface of the upper plate and a separation layer between the upper opening and the lower opening of the upper plate;
a lower collection device arranged below the upper plate, the collection device having one or more wells arranged in register with the two or more wells of the upper plate to receive liquid from the openings of the upper plate; and
wherein the opening is capable of forming a pendant drop of a radius of R, and wherein the spout is offset from an inner wall of the one or more wells of the collection device by a distance of from about 0.05 R to about 0.95 R.

It is an additional object to provide a device for separating a liquid sample comprising:
an upper plate having at least two wells integrally connected together, each well having an upper opening and a lower opening, the lower opening being smaller than the upper opening and in the form of a spout, the lower opening being positioned on a bottom surface of the upper plate and a separation layer between the upper opening and the lower opening of the upper plate;
a lower collection plate arranged below the upper plate, the collection device having one or more wells arranged in register with the two or more wells of the upper plate to receive liquid from the spouts of the upper plate; and
wherein the spout has the ability to form a pendant drop of a radius R, the spout being located adjacent at least one wall of the collection device well by a distance of between 0.05 R and less than about 1 R. We changed from openings to spouts here, was that the intention?

It is another object of the present invention to provide a multiple well plate filtration system comprising a filter plate having a top, a bottom and a thickness between the top and the bottom, a plurality of wells extending through the thickness, each well having an open top and at least a partially open bottom, a filter sealed adjacent the bottom to form a permeably selective opening to the bottom, an underdrain having a top surface, a bottom surface and a thickness in between, the top surface of the underdrain attached to the bottom of the plate, the underdrain having a series of chambers formed in its thickness that register and mate with the bottom of the plurality of wells of the plate so as to ensure that fluid passing the filter of a selected well enters only the respective chamber of the underdrain, each chamber having an opening through the bottom surface of the underdrain to an outside environment, a collection device located below the underdrain, the collection device having a top, a bottom and a thickness between the top and the bottom, a plurality of wells extending through the thickness, each well having an open top, each well of the collection device is in align with a well of the filter plate and its associated underdrain chamber and opening, each opening being offset from a centerpoint determined by the intersection of two or more diameters of the registered well of the collection device, the vertical centerline and an inner wall of the collection plate being separated by a distance A and the opening being from about 0.05 A to less than about the distance A from the inner wall of the well of the collection plate.

### BRIEF DESCRIPTION OF THE DRAWINGS

FIG. 1 shows the plate system of the prior art.

FIG. 2 shows a filter plate with underdrain in cross-sectional view according to one embodiment of the present invention.

FIG. 3 shows a filter plate with underdrain in cross-sectional view according to another embodiment of the present invention.

FIG. 4 shows a filter plate with underdrain in cross-sectional view according to a further embodiment of the present invention.

FIG. 5 shows a top down view of one well a filter plate according to the embodiment of FIG. 2 of the present invention.

FIG. 6 shows a top down view of one well a filter plate according to another embodiment of FIG. 2 of the present invention.

FIG. 7 shows a top down view of one well a filter plate according to an embodiment of FIG. 3 of the present invention.

FIG. 8 shows a top down view of one well a filter plate according to the embodiment of FIG. 4 of the present invention.

FIG. 9 shows a top down view of one well a filter plate according to a further embodiment of FIG. 2 of the present invention.

FIG. 10 shows a cross-sectional view of another embodiment of the present invention.

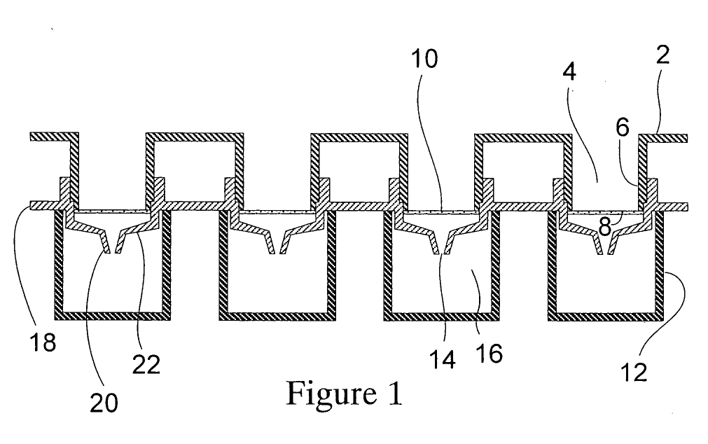

### DETAILED DESCRIPTION OF THE INVENTION

The present invention relates to the control and preferably recovery of pendant drops formed on the bottom of an underdrain in a multiwell filtration plate system.

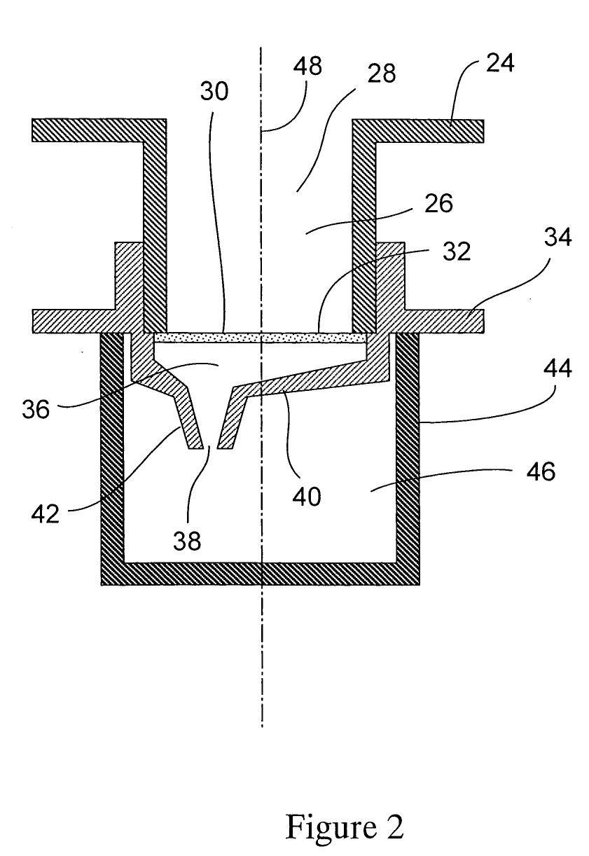

The invention can be demonstrated by the first embodiment of the present invention as shown in FIG. 2. In this embodiment, the filter plate 24 has a series of wells 26, of which only one is shown in close up view. The top 28 of each well 26 is open and the bottom 30 of each well 26 is selectively closed by a filter 32. An underdrain 34 is attached to the bottom 30 of each well and has a chamber 36 for receiving fluid that has passed through the filter 32, an opening 38 formed in its bottom surface 40 that provides a fluid pathway out of the underdrain 34 with the opening 38 as shown in one preferred embodiment terminating in a spout 42. As shown, optionally the bottom 40 of the underdrain 34 all tapers toward the opening 38 to allow for easy fluid movement. Also shown below the underdrain 34 is a collection device (here in the form of a collection plate) 44 that is formed of multiple wells 46, that typically are in the same number and in register with the wells 26 of the filter plate 24. In another embodiment the device 44 is a single well plate where the individual filtrate is either not of interest or the overall filtrate is not of interest and the desire is mainly to remove as much filtrate from the system as possible. Also while shown with a closed bottom, the device 44 may also have an open bottom if desired. In another embodiment, the collection device may contain or be a series of ribs or grids in the bottom of a pressure differential manifold (such as a vacuum manifold) that help collect and transfer the filtrate to a common collection place or to waste. While most embodiments will be discussed in relation to a collection plate, it is meant to cover and include other collection devices as well.

As shown, the opening 38 and the spout 42 of the underdrain 34 are arranged to be offcenter of a vertical centerline 48 of the well 46 of the collection device 44. Also as shown in this embodiment they are offcenter of the same vertical centerline 48 of the well 26 of the filter plate 24 although as explained in further detail below, it need not be.

The centerline can be determined by a variety of means. One simple means is to simply take two or more diameters of the well 46, preferably three or more especially when there may be two or more different diameters in the well 46 (such as in a rectangular, oval or teardrop shaped well) and to note the point where they intersect. A vertical line can then be formed through that intersection point to yield a vertical centerline for the well. Another method is to simply determine the center or innermost radius point of the well and draw a vertical centerline through it. Other methods may also be used.

By setting the opening 38 and/or spout 42 (if used) off from the centerline of the well, they are located closer to one wall of the well than the other. In this way, a drop formed on the opening 38 or spout 42 will preferentially move toward that wall and be drawn by surface energy into the collection device 44 below.

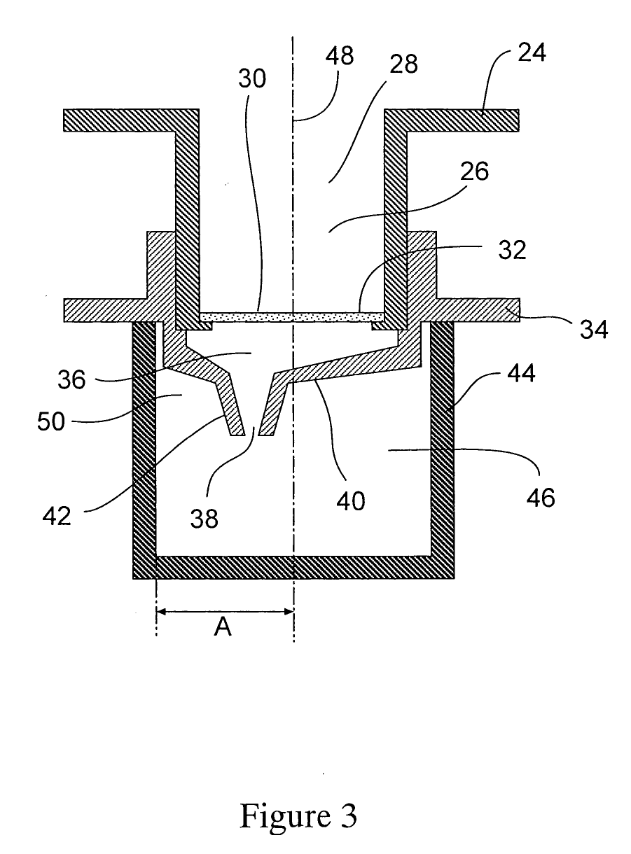

In another embodiment of the present invention shown in FIG. 3, the spout 42 (if used) and opening 38 are between the vertical centerline 48 of the collection device well 46 and or the filter plate well 26 and the inner wall 50 of the collection device 44 by a distance that is from about 0.05 A to less than about the distance A between the vertical centerline 48 and the inner wall 50, preferably from about 0.05 to about 0.95 the distance A between the vertical centerline 48 and the inner wall 50.

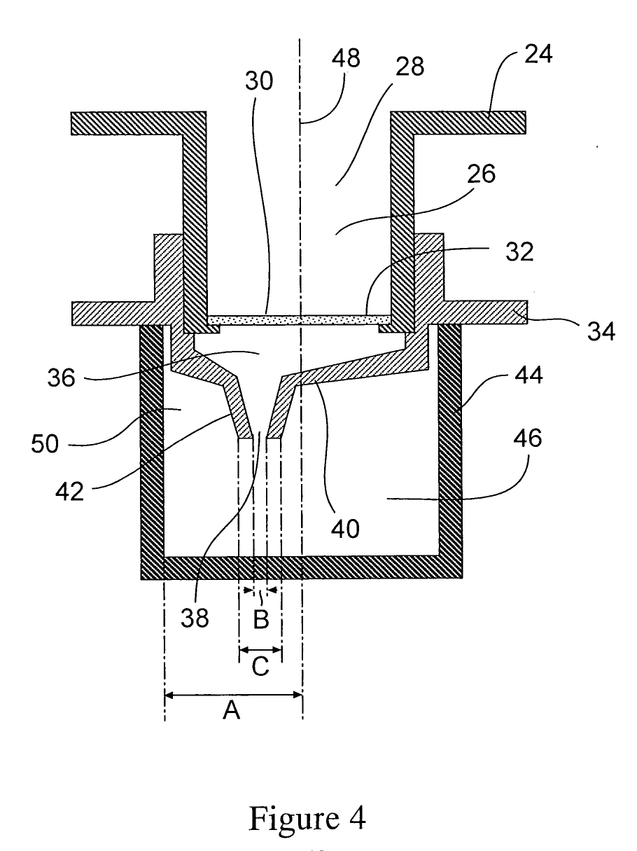

In a further embodiment shown in FIG. 4, a pendant drop will generally form of a similar radius R for a given spout design. This is especially true for spouts when the ratio of the inside diameter B to the outside diameter C of the spout is >0.2. Then a pendant drop will form a maximum drop of radius R for that given spout design with a given fluid type. The drop radius may change when one uses an aqueous based fluid versus a fluid with lower surface tension such as an alcohol-based, surfactant containing or solvent-based fluid. The effect remains essentially the same for a given type of fluid. Most applications are aqueous based and one can generally use an aqueous fluid for this determination.

Knowing this and using this, one can then position the spout 42 adjacent to but not in contact with the inner wall 50 such that a drop formed on the spout 42 will always contact the inner wall before reaching its full dimension and therefore be carried into the collection device 46. To state this in an empirical formula when the ratio of B:C of the opening 38 is ≧0.2, the drop will have a radius R for a given type of fluid, and the spout 42 and opening 38 location may be from about 0.05 R to less than about 1 R away from a surface 50 of the collection device, preferably from about 0.05 R to about 0.95 R away from the surface 50 of the collection device.

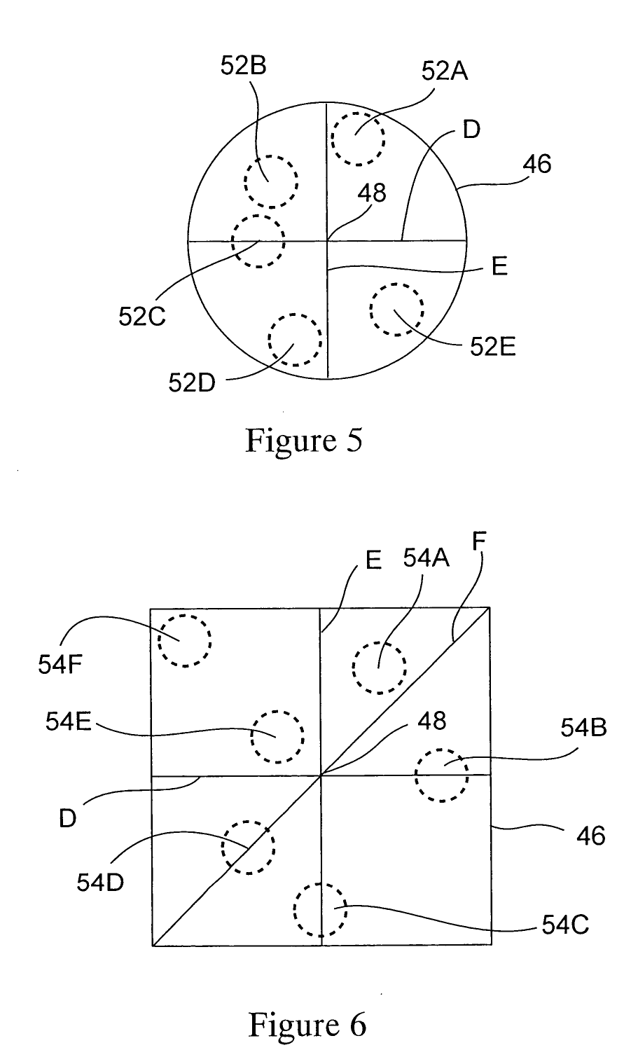

FIG. 5 shows a top down view of the embodiment of FIG. 2 using a round collection plate well 46 with the determination of the vertical centerline 48 by the intersection of two diameters D and E. Also shown in ghost images are just some of the various possible spout 42/opening 38 locations 52A-E when the underdrain 34 is mated with the collection plate well 46. As can be seen all that is required is that the spout 42 and opening 38 be offcenter of the vertical centerline 48.

FIG. 6 shows a top down view of the embodiment of FIG. 2 using a rectangular collection plate well 46 with the determination of the vertical centerline 48 by the intersection of three diameters D, E and F. Also shown in ghost images are just some of the various possible spout 42/opening 38 locations 54A-F when the underdrain 34 is mated with the collection plate well 46. As can be seen all that is required is that the spout 42 and opening 38 be offcenter of the vertical centerline 48.

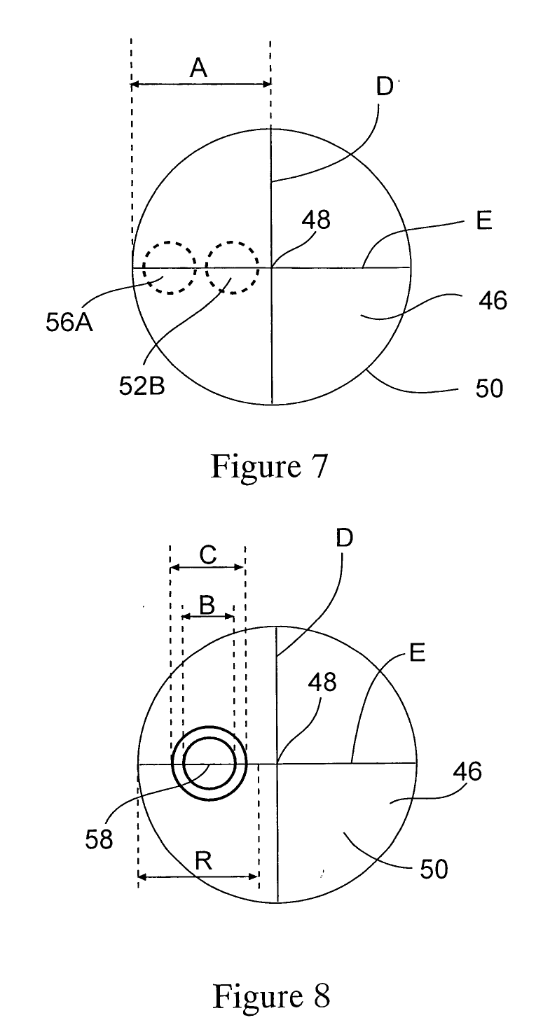

FIG. 7 shows a top down view of the embodiment of FIG. 3 using a round collection plate well 46 with the determination of the vertical centerline 48 by the intersection of two diameters D and E. Also shown in ghost images are just two of the various possible spout 42/opening 38 locations 56A and B when the underdrain 34 is mated with the collection plate well 46. As can be seen, the locations 56A and 56B are positioned by a distance that is from 0.05 to 0.95 the distance A between the vertical centerline 48 and the inner wall 50.

FIG. 8 shows a top down view of the embodiment of FIG. 4 using a round collection plate well 46 with the determination of the vertical centerline 48 by the intersection of two diameters D and E. Also shown in ghost image is just one of the various possible spout 42/opening 38 locations 58 when the underdrain 34 is mated with the collection plate well 46. As can be seen, the ratio of the inner diameter B to the outer diameter C of the spout 42 is equal to or greater than 0.2 resulting in a drop radius of R. The location of the spout 42 and opening 38 should be from 0.05 to 0.95 R from the inner wall 50 of the well 46.

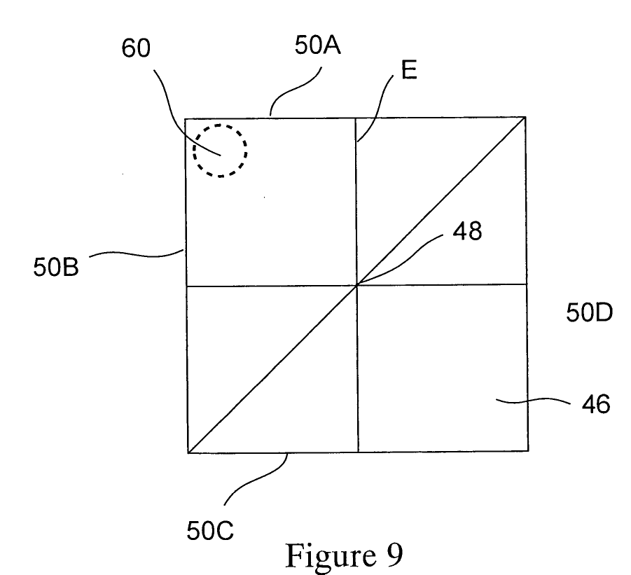

FIG. 9 shows an additional embodiment of the present invention that can be used with any of the embodiments of FIGS. 24. In this embodiment, the collection device well 46 is square the shape as currently is used in most 384 well collection plates. By offsetting the location 60 of the spout 42/opening 38 properly, one can take advantage of the square well design. The square well has four walls 50A-D with two walls for example 50A and 50B or 50B and 50C meeting in a corner. One can position the location 60 of the spout 42/opening 38 so as to be offset from the centerline 48 and to be between the two walls 50A and 50B for example in or adjacent to the corner formed by the intersection of those two walls 50A and 50B. In this manner, one has twice the surface with which to have the drop interact and therefore one can obtain faster and more complete transfer of the drop to the collection device 46.

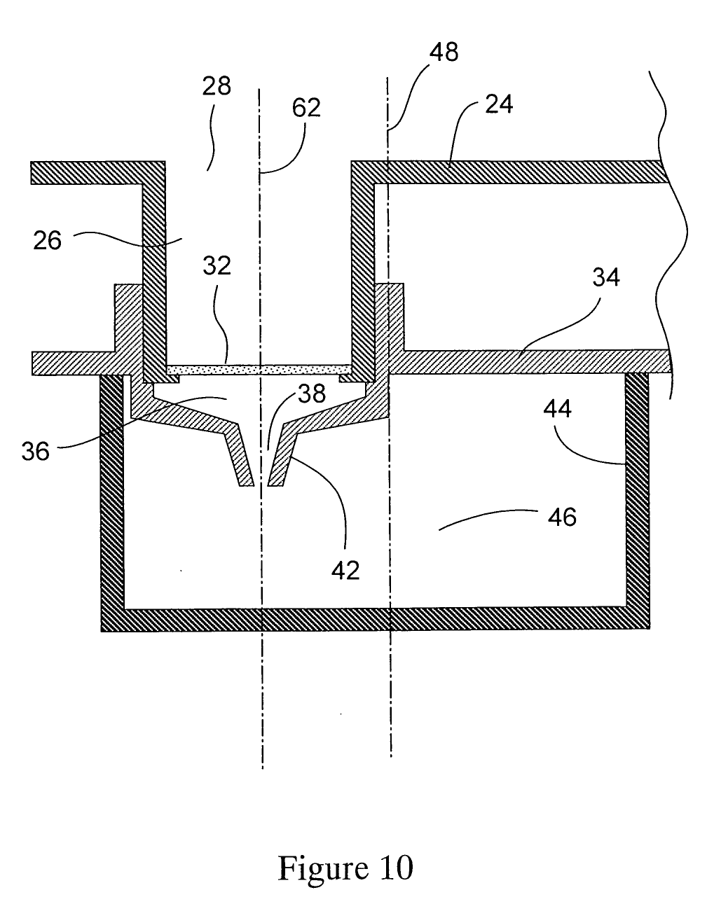

FIG. 10 shows another embodiment of the present invention. In this embodiment, the spout 42/opening 38 of the underdrain 34 is still located offcenter of the vertical centerline 48 of the collection device well 46. However, the location of the spout 42/opening 38 is in line with the centerline of the filter plate vertical centerline 62 (which is determined in a manner similar to that of the collection device centerline 48). This can be accomplished for example by using a collection device well 46 which is large enough so that the spout of the underdrain is positioned offcenter of its vertical centerline 48 and placing the spout closer to one or more walls 50 of the collection device well 46 than the others. Other means of obtaining the same effect can be used as well with the present invention.

In addition to pulling pendant drops into the well of the collection plate rather than having them hang there and potentially lead to contamination or crosstalk, the present invention has other advantages. One advantage is that by offsetting the opening/spout location, one does not trap an air bubble in the well as the fluid flows into the collection plate as can occur with a centered spout/opening design, especially with the smaller well sizes such as 384 and 1536 well plates. Another advantage is that the design tends to reduce splashing and vaporization of the fluid as it flows into the well as the wall appears to act as a dampener and controls the flow of the fluid into the well in a more even and controlled manner. Other advantages of the present invention may also exist.

The underdrain can be an integral component of the filter plate, having been molded as part of the plate, overmolded on to a preformed plate or preformed separately and bonded to a preformed plate. Alternatively, it can be preformed and releasably attached to the bottom of a preexisting plate.

Suitable polymers which can be used to form the underdrain, collection plate and the filter plate include but are not limited to polycarbonates, polyesters, nylons, PTFE resins and other fluoropolymers, acrylic and methacrylic resins and copolymers, polysulphones, polyethersulphones, polyarylsulphones, polystyrenes, polyvinyl chlorides, chlorinated polyvinyl chlorides, ABS and its alloys and blends, polyolefins, preferably polyethylenes such as linear low density polyethylene, low density polyethylene, high density polyethylene, and ultrahigh molecular weight polyethylene and copolymers thereof, polypropylene and copolymers thereof and metallocene generated polyolefins.

Preferred polymers are polyolefins, in particular polyethylenes and their copolymers, polystyrenes and polycarbonates.

The underdrain, collection plate and filter plate may be made of the same polymer or different polymers as desired.

Likewise the polymers may be clear or rendered optically opaque or light impermeable. When using opaque or light impermeable polymers, it is preferred that their use be limited to the side walls so that one may use optical scanners or readers on the bottom portion to read various characteristics of the retentate. When the filter is heat bonded to the underdrain, it is preferred to use polyolefins due to their relatively low melting point and ability to form a good seal between the device and the filter.

One may use one or more filters in a given device. Typically, one filter layer is used, although some applications may require two or more filter layers (sometimes as a prefilter or to perform other desired functions). The filter(s) may be of any variety commonly used in filtering biological specimens including but not limited to microporous membranes, ultrafiltration membranes, coarse filters such as fibrous mats or papers, nanofiltration membranes, or reverse osmosis membranes. Preferably microporous membranes, ultrafiltration membranes, coarse filters or nanofiltration membranes are used. Even more preferably, microporous, coarse filters and ultrafiltration membranes are used.

Representative suitable microporous membranes include nitrocellulose, cellulose acetate, polysulphones including polyethersulphone and polyarylsulphones, polyvinylidene fluoride, polyolefins such as ultrahigh molecular weight polyethylene, low density polyethylene and polypropylene, nylon and other polyamides, PTFE, thermoplastic fluorinated polymers such as poly (TFE-co-PFAVE), polycarbonates or particle filled membranes such as EMPORE® membranes available from 3M of Minneapolis, Minn. Such membranes are well known in the art and are commercially available from a variety of sources including Millipore Corporation of Billerica, Mass. If desired these membranes may have been treated to render them hydrophilic. Such techniques are well known and include but are not limited to grafting, crosslinking or simply polymerizing hydrophilic materials or coatings to the surfaces of the membranes.

Representative ultrafiltration or nanofiltration membranes include polysulphones, including polyethersulphone and polyarylsulphones, polyvinylidene fluoride, and cellulose. These membranes typically include a support layer that is generally formed of a highly porous structure. Typical materials for these support layers include various non-woven materials such as spun bounded polyethylene or polypropylene, or glass or microporous materials formed of the same or different polymer as the membrane itself. Such membranes are well known in the art, and are commercially available from a variety of sources such as Millipore Corporation of Billerica, Mass.

Suitable coarse filters include glass mats, glass fibers, fibrous mats of cellulosic material or plastic and the like as well as filter papers such as pH papers or DEAE papers.

As described above, with the use of a plurality of wells, it is important that at least some, preferably all the wells of the first plate register with the well(s) of the collection device. Typically multiple well plates have been made in formats containing 6, 96, 384 or 1536 wells and above. The number of wells used is not critical to the invention. This invention may be used with any multiple number of wells provided that the filter is capable of being secured to the filter plate in a manner that locates it adjacent to the bottom of the well and preferably forms a liquid tight seal between the periphery of the filter and the end of the wells of the plate. The wells are typically arranged in mutually perpendicular rows. For example, a 96 well plate will have 8 rows of 12 wells. Each of the 8 rows is parallel and spaced apart from each other. Likewise, each of the 12 wells in a row is spaced apart from each other and is in parallel with the wells in the adjacent rows. A plate containing 1536 wells typically has 128 rows of 192 wells. The wells may have a shape that is round, square, rectangular, triangular other polygonal shape, oval, teardrop or any other design commonly used in such plates.

A variety of methods for forming the filter plate according to the present invention may be used. Any method which locates and preferably seals the membrane within the well of the plate or on to the bottom of the plate (in the single plate design) and on or in the well of the bottom plate (in the two plate design) such that all fluid within the well must pass through the filter before leaving the well through the bottom opening will be useful in this invention.

One method of forming such a device is to form a single plate of a suitable plastic as described above and use a mechanical seal between the well wall and the filter. In this embodiment, there is an undercut formed around the periphery of the inner wall of the well. The filter is sized so as to fit within the undercut portion of the well. The filter is placed within the well. Optionally, a sealing gasket is applied on top of the filter within the undercut. This sealing gasket applies pressure to the filter and ensures that all the fluid must pass through the filter thereby eliminating any leakage or bypass of the filter by the fluid. This gasket may be in the form of a preformed gasket such as an O-ring. Alternatively, a gasket formed of a molten or liquid material may be cast into the undercut to seal the filter in place. An example of a molten material suitable for this embodiment, are any of the well-known hot melt materials such as polyethylene or polypropylene or ethylene vinyl acetate copolymers. A liquid gasket may be formed of any curable rubber or polymer such as an epoxy, urethane or synthetic rubber.

Another method of forming such a device is to use an adhesive to bond and seal the edge of the filter within the well such as all fluid must pass through the filter before entering the opening in the bottom of the well. Adhesive may be either molten or curable as discussed above.

A further method is to use a thermal bond to secure the filter to the well. In this embodiment, a filter sealing device which has a sealing surface which is heated is brought into contact with the upper filter surface and transfer its thermal energy to the surrounding filter and well material. The energy causes either the filter material or the well materials or both to soften and or melt and fuse together forming an integral, fluid tight seal. This process may be used when either the filter material or the well material or both are formed of a thermoplastic material. It is preferred that the well as well as at least a portion of the filter material adjacent the downstream side of the filter be formed of a thermoplastic material. The sealing surface is only a portion of the filter surface and is a continuous structure so that a ring or peripheral area of the filter is sealed to the well so as to form a liquid tight seal between the filter, the well and the opening in the bottom of the well.

1) A multiple well filter plate comprising a plate having a top, a bottom and a thickness between the top and the bottom, a plurality of wells extending through the thickness, each well having an open top and at least a partially open bottom, a filter located adjacent the bottom to form a permeably selective opening to the bottom, an underdrain having a top surface, a bottom surface and a thickness in between, the top surface of the underdrain attached to the bottom of the plate, the underdrain having a series of chambers that each register and mate with the bottom of each of the plurality of wells of the plate so as to ensure that fluid passing through the filter of a selected well enters only the respective chamber of the underdrain, each chamber having an opening through the bottom surface of the underdrain to an outside environment and each opening being offset from a centerpoint determined by the intersection of two or more diameters of the registered well of the plate and chamber of the underdrain.

2) The plate of claim 1 further comprising a chamber that has one or more sloped surfaces extending from its periphery to the opening.

3) The plate of claim 1 further comprising a chamber that has one or more sloped surfaces extending from its periphery to the opening and is in the form of a spout extending downwardly from the bottom surface of the underdrain.

4) The plate of claim 1 wherein the filter is contained within the well.

5) The plate of claim 1 wherein the bottom of each well is open and the filter is sealed across the bottom of each well.

6) The plate of claim 1 wherein the filter is located adjacent the bottom of each well.

7) A multiple well plate filtration system comprising a filter plate having a top, a bottom and a thickness between the top and the bottom, a plurality of wells extending through the thickness, each well having an open top and at least a partially open bottom, a filter located adjacent the bottom to form a permeably selective opening to the bottom, an underdrain having a top surface, a bottom surface and a thickness in between, the top surface of the underdrain attached to the bottom of the plate, the underdrain having a series of chambers formed in its thickness that register and mate with the bottom of the plurality of wells of the plate so as to ensure that fluid passing the filter of a selected well enters only the respective chamber of the underdrain, each chamber having an opening through the bottom surface of the underdrain to an outside environment, a collection device located below the underdrain, the collection device having a top, a bottom and a thickness between the top and the bottom, a plurality of wells extending through the thickness, each well having an open top and a bottom, each well of the collection device is in align with a well of the filter plate and its associated underdrain chamber and opening and the opening of the underdrain has the ability to form a pendant drop of a radius R, the opening being located adjacent at least one wall of the collection device well by a distance of between 0.05 R and <1 R.

8) A multiple well plate filtration system comprising a filter plate having a top, a bottom and a thickness between the top and the bottom, a plurality of wells extending through the thickness, each well having an open top and at least a partially open bottom, a filter sealed adjacent the bottom to form a permeably selective opening to the bottom, an underdrain having a top surface, a bottom surface and a thickness in between, the top surface of the underdrain attached to the bottom of the plate, the underdrain having a series of chambers formed in its thickness that register and mate with the bottom of the plurality of wells of the plate so as to ensure that fluid passing the filter of a selected well enters only the respective chamber of the underdrain, each chamber having an opening through the bottom surface of the underdrain to an outside environment, a collection device located below the underdrain, the collection device having a top, a bottom and a thickness between the top and the bottom, a plurality of wells extending through the thickness, each well having an open top and a bottom, each well of the collection device is in align with a well of the filter plate and its associated underdrain chamber and opening and the opening of the underdrain has an outside diameter of C and an inside diameter of B, the division of B by C is >0.2, the opening being capable of forming a pendant drop of a radius of R, and wherein the opening is offset from an inner wall of the well of the collection plate by a distance of from about 0.05 R to less than 1 R.

9) A device for separating a liquid sample comprising:
an upper plate having at least two wells integrally connected together, each well having an upper opening and a lower opening, the lower opening being positioned on a bottom surface of the upper plate and a separation layer between the upper opening and the lower opening of the upper plate;
a lower collection device arranged below the upper plate, the collection device having one or more wells arranged in register with the two or more wells of the upper plate to receive liquid from the openings of the upper plate; and
wherein the opening is capable of forming a pendant drop of a radius of R, and wherein the opening is offset from an inner wall of the one or more wells of the collection device by a distance of from about 0.05 R to less than 1 R.

10) A device for separating a liquid sample comprising:
an upper plate having at least two wells integrally connected together, each well having an upper opening and a lower opening, the lower opening being smaller than the upper opening and in the form of a spout, the lower opening being positioned on a bottom surface of the upper plate and a separation layer between the upper opening and the lower opening of the upper plate;
a lower collection device arranged below the upper plate, the collection device having one or more wells arranged in register with the two or more wells of the upper plate to receive liquid from the spouts of the upper plate; and
wherein the opening has the ability to form a pendant drop of a radius R, the opening being located adjacent at least one wall of the collection device well by a distance of between about 0.05 R and < about 1 R.

11) A multiple well plate filtration system comprising a filter plate having a top, a bottom and a thickness between the top and the bottom, a plurality of wells extending through the thickness, each well having an open top and at least a partially open bottom, a filter located adjacent the bottom to form a permeably selective opening to the bottom, an underdrain having a top surface, a bottom surface and a thickness in between, the top surface of the underdrain attached to the bottom of the plate, the underdrain having a series of chambers formed in its thickness that register and mate with the bottom of the plurality of wells of the plate so as to ensure that fluid passing the filter of a selected well enters only the respective chamber of the underdrain, each chamber having an opening through the bottom surface of the underdrain to an outside environment, a collection device located below the underdrain, the collection device having a top, a bottom and a thickness between the top and the bottom, a plurality of wells extending through the thickness, each well having an open top , each well of the collection device is in register with a well of the filter plate and its associated underdrain chamber and opening so as to collect the fluid therefrom, each opening being offset from centerpoint of the well of the collection device, and the centerpoint and an inner wall of the collection device being separated by a distance A and the opening being from about 0.05 the distance A to less than about the distance A from the inner wall of the well of the collection device.

12) A multiple well plate filtration system comprising a filter plate having a top, a bottom and a thickness between the top and the bottom, a plurality of wells extending through the thickness, each well having an open top and at least a partially open bottom, a filter located adjacent the bottom to form a permeably selective opening to the bottom, an underdrain having a top surface, a bottom surface and a thickness in between, the top surface of the underdrain attached to the bottom of the plate, the underdrain having a series of chambers formed in its thickness that register and mate with the bottom of the plurality of wells of the plate so as to ensure that fluid passing the filter of a selected well enters only the respective chamber of the underdrain, each chamber having an opening through the bottom surface of the underdrain to an outside environment, a collection device located below the underdrain, the collection device having a top, a bottom and a thickness between the top and the bottom, a plurality of wells extending through the thickness, each well having an open top, each well of the collection device is in align with a well of the filter plate and its associated underdrain chamber and opening, each opening being offset from a centerpoint determined by the intersection of two or more diameters of the registered well of the collection device, the vertical centerline and an inner wall of the collection plate being separated by a distance A and the opening being from about 0.05 the distance A to less than about the distance A from the inner wall of the well of the collection plate.

13) The system of claim 7 the collection device has a series of wells and the shape of the wells are selected from the group consisting of round, oval, teardrop, square and polygonal.

14) The system of claim 7 the collection device has a series of wells and the shape of the wells is square.

15) The system of claim 7 the collection device has a series of wells, the shape of the wells is square and the openings of the underdrain are located in a corner of each square well.

16) The device of claim 9 the collection device has a series of wells and the shape of the wells are selected from the group consisting of round, oval, teardrop, square and polygonal.

17) The device of claim 9 the collection device has a series of wells and the shape of the wells is square.

18) The device of claim 9 the collection device has a series of wells, the shape of the wells is square and the openings of the underdrain are located in a corner of each square well.

19) The device of claim 10 the collection device has a series of wells and the shape of the wells are selected from the group consisting of round, oval, teardrop, square and polygonal.

20) The device of claim 10 the collection device has a series of wells and the shape of the wells is square.

21) The device of claim 10 the collection device has a series of wells, the shape of the wells is square and the openings of the underdrain are located in a corner of each square well.

22) The system of claim 11 the collection device has a series of wells and the shape of the wells are selected from the group consisting of round, oval, teardrop, square and polygonal.

23) The system of claim 11 the collection device has a series of wells and the shape of the wells is square.

24) The system of claim 11 the collection device has a series of wells, the shape of the wells is square and the openings of the underdrain are located in a corner of each square well.

25) The system of claim 12 the collection device has a series of wells and the shape of the wells are selected from the group consisting of round, oval, teardrop, square and polygonal.

26) The system of claim 12 the collection device has a series of wells and the shape of the wells is square.

27) The system of claim 12 the collection device has a series of wells, the shape of the wells is square and the openings of the underdrain are located in a corner of each square well.

28) The system of claim 7 wherein the collection device has a single well and the well contains a structure selected from the group consisting of ribs and grids.

29) The device of claim 9 wherein the collection device has a single well and the well contains a structure selected from the group consisting of ribs and grids.

30) The device of claim 10 wherein the collection device has a single well and the well contains a structure selected from the group consisting of ribs and grids.

31) The system of claim 11 wherein the collection device has a single well and the well contains a structure selected from the group consisting of ribs and grids.

32) The system of claim 12 the collection device has a single well and the well contains a structure selected from the group consisting of ribs and grids.
